(19) United States
(12) Patent Application Publication
(10) Pub. No.: US 2013/0088153 A1
(43) Pub. Date: Apr. 11, 2013

(54) METHOD OF CONTROLLING ELECTRICAL DEVICES, PARTICULARLY LIGHTING LAMPS AND CONTROL SYSTEM OF ELECTRICAL DEVICES, PARTICULARLY LIGHTING LAMPS

(71) Applicant: Krzysztof Wlodzimierz Lagutko, Warszawa (PL)

(72) Inventor: Krzysztof Wlodzimierz Lagutko, Warszawa (PL)

(21) Appl. No.: 13/582,217

(22) PCT Filed: Mar. 3, 2011
(86) PCT No.: PCT/PL11/00027

§ 371 Date: Dec. 10, 2012

(30) Foreign Application Priority Data
Mar. 4, 2010 (PL) P.390613

(51) Int. Cl. H05B 37/02

(52) U.S. Cl. CPC H05B 37/02
USPC 315/152; 315/312

(57) ABSTRACT

A system for controlling electrical devices, particularly external lighting lamps, connected to a supply network, the system comprising at least one management and diagnostic centre with communication modules, fed by the supply network, and external lighting lamps, connected to the supply network, wherein the lamps contain controlling modules and communication modules, whilst exchange of data between management and diagnostic centre and individual lamps as well as between lamps themselves takes place in real time, within set communication cycles, wherein said data can be preserved in individual lamps, in an MCU MASTER main controlling unit of the lamp and transmitted to other lamps after closing the communication cycle with said at least one management and diagnostic centre, and wherein changes transmitted from said at least one management and diagnostic centre are carried out by said MCU MASTER main controlling unit of each lamp.

### FIELD OF THE INVENTION

The object of invention relates to the method of controlling electrical devices, particularly lighting lamps, the electrical devices' control system, particularly lighting lamps', the method of lighting lamps' control and the lighting lamp, advisable for external lighting.

### BACKGROUND OF THE INVENTION

The automatic power control unit of lighting loads, containing a four-function controller with final contact unit, connected to a switch unit, selecting one of a number input voltage levels for connection to the load, provided by a transformer is known from the U.S. Pat. No. 4,189,664. The regulator includes an unit, controlling input voltage, a delay unit for timing periods when voltage is reduced or increased, a clock unit controlling moments of switching on and off the lighting as well as an external control unit, connected to a number of external control elements, such as photodetector measuring the light level or a master computer controlling the object. The combination of outputs of these units, carried into effect in final contact unit, governs the switch unit, connecting particular taps of autotransformer to the output. The connection is effected in such manner, that the load connected to the tap being used at the moment is being switched off; and—after a while—the contactor of the successive tap is being connected with it, switching on lighting feeding from this tap—with less or higher voltage value. The drawback of this method is, that it causes transitory supply breaks, which in case of discharge lamps used for street lighting is followed by their extinction and repeated ignition, giving an unpleasant effect of their flickering as well as transitory lack of lighting. Moreover, the control unit is fed from the same power source as the loads, and due to that, breaks in supply may disturb its operation, which not always can be replaced by an external control. The combination of taps connection in the final contact unit is the solution of low reliability.

The system, controlling supply of electrical loads—street lighting, equipped with a microprocessor unit, with memory containing a program of street lighting seasonal switching on/off, together with a clock unit for ensuring twenty-four hours' control of loads' supply, through their switch on at specified time, periodic change of feeding voltage—through its temporary decrease and increase, up to their switch off at specified time, is known from Polish patent specification No. 180160. The method consists in transmitting signals from microprocessor unit to voltage regulation device, which switch on and off voltage regulation device, composed of an autotransformer with motor drive slide or tap switch.

The drawback of this system is, that the change in feeding voltage is effected under the load. In case the solution using the slide is applied, it causes contacts' sparking and autotransformer's winding burn-out. In case of solution with tap switch, it causes transitory supply breaks, which in case of discharge lamps used for street lighting is followed by their extinction and repeated ignition, giving an unpleasant effect of their flickering as well as transitory lack of lighting. Moreover, the control unit is fed from the same power source as the loads, and due to that, breaks in supply may disturb its operation, which not always can be replaced by an external control.

The method and system of electric loads' power supply control, particularly street lighting, fed by an autotransformer equipped with taps, and switched on/over by a controller, comprising a processor, connected to memory containing a program of street lighting seasonal switching on/off, together with a clock unit for ensuring twenty-four hours' control of loads' supply, through their switch on/off at specified, requested time and voltage adjustment through a sequential control of relay unit, controlling contactors switching on/off the particular taps of autotransformer supplying electric loads is known from Polish patent application No. P 355513. The a/m method consists in this, that switching the power supply from one autotransformer's tap to a successive tap is effected by switching on first the contactor of tap, to which the loads' power supply is being switched, and then—after a short interval of time, predetermined by use of signalling and data setting unit—contactors of tap from which the loads were fed are being switched off.

The drawback of this system is, that it causes transitory supply breaks, which in case of discharge lamps used for street lighting is followed by their extinction and repeated ignition, giving an unpleasant effect of their flickering as well as transitory lack of lighting. Moreover, the control unit is fed from the same power source as the loads, and due to that, breaks in supply may disturb its operation, which not always can be replaced by an external control.

The method of controlling electrical devices, particularly lighting lamps, connected to the common supply network, when the devices exchange information through the electric power supply network is known from the European patent specification No. EP 1 483 819.

The aim of the present invention consists in elaborating a method of controlling electrical devices, particularly lighting lamps, having no drawbacks of methods already known, and allowing to control electrical devices regardless the supply network, to which they are connected.

The aim of the present invention consists also in elaborating an electrical devices' control system, particularly lighting lamps' control system, allowing to choose any area size for lighting provided by lamps, regardless their supply network, for example—when they are connected to two or more independent networks.

The aim of the present invention moreover consists also in elaborating a method of lighting lamps' control, in order to optimize their working parameters and to reduce energy consumption.

The aim of the present invention consists also in constructing an “intelligent” lighting lamp.

### SUMMARY OF THE INVENTION

The aim of invention has been achieved by elaborating a method of controlling electrical devices, particularly external lighting lamps, connected to the supply network. The method consists in this, that management and diagnostic centre as well as lighting lamps are equipped with individual controlling modules and radio-communication or GSM modules. The modules of particular lighting lamps are synchronized with each other and with the management and diagnostic centre. They exchange information through the radio network or GSM regardless the power supply network in the predetermined communication cycles, and the information can be preserved in lamps' controlling modules and transmitted to other lighting lamps after terminating communication cycle with the management and diagnostic centre, if such information is assigned for other lighting lamps working in the area.

Advantageously, the lighting lamps send individual information about their working conditions and predetermined parameters and receive information from management and diagnostic centre concerning working conditions and parameters to be set by each individual lamp.

Advantageously, the lamps exchange information with the main lamp in a given operation area and said main lamp collects such information and sends it to the management and diagnostic centre, and transmits information received from the management and diagnostic centre to each, individual lamp.

The aim of the invention has been also achieved by elaborating an electrical devices' control system, particularly the system, controlling lighting lamps connected to the supply network which system contains at least one management and diagnostic centre with communication modules, fed by any supply network, and external lighting lamps, connected to any supply network, and these lamps contain controlling modules and communication modules, whilst exchange of data between management and diagnostic centre and individual lamps as well as between lamps themselves takes place in real time, within set communication cycles and said information can be preserved in individual lamps, in MCU MASTER main controlling unit of the lamp and transmitted to other lamps after closing the communication cycle with management and diagnostic centre, and changes transmitted from management and diagnostic centre are carried out by MCU MASTER main controlling unit of each lamp.

The aim of the invention has been also achieved by elaborating a method of controlling a lighting lamp according to which, lamp working parameters are introduced into MCU MASTER main controlling unit memory, then signals controlling the lamp are transmitted from management and diagnostic centre via radio or GSM, whilst the informations are preserved and transmitted by MCU MASTER main controlling unit of the lamp, which automatically carries out the appropriate changes in lamp working program, as well as it executes commands inserted previously into MCU MASTER main controlling unit memory, and also transmits to management and diagnostic centre information about lamp working conditions and parameters measured by sensors.

Advantageously, measurements of lamp and environment temperature, as well as input power values, are effected by the lamp, and their results are taken into account when carrying out transmitted or memorized commands.

Advantageously, measurements are effected by lamp sensors, connected to MCU MASTER main controlling unit, and measurement results are taken into account when carrying out transmitted or memorized commands.

Advantageously, signals of lamp working conditions, containing information about lamp and environment temperature, as well as input power values and measurements effected by lamp sensors are preserved in MCU MASTER main controlling unit memory and send to management and diagnostic centre, where measurement results are taken into account when working out and transmitting to the lamp information from management and diagnostic centre.

The aim of the invention has been also achieved by constructing a lighting lamp, used particularly for external lighting, containing a main controlling module, a sensors' module, at least one module of feeder and at least one module with HB LED diodes and the main controlling module contains MCU MASTER main controlling unit, connected to radio transmitter/receiver assigned for transfering data, to lamp and environment temperature measurement module, to sensors' module, and at least to one MCU central controlling unit of lighting elements' feeder module.

Advantageously, ISM radio modem, GSM/GPRS radio modem is the radio transmitter/receiver.

Advantageously, ISM radio transmitter and GSM transmitter is the radio transmitter/receiver.

Advantageously, the MCU MASTER main controlling unit is equipped with a memory, enabling to preserve information, containing transmitted commands, concerning lighting intensity control, lighting time, lighting switch on/off time and the MCU MASTER main controlling unit automatically executes commands inserted previously and not changed, as well as preserves data received from sensors and transmits this information automatically or on request.

Advantageously, the feeder's module contains a central MCU unit, controlling its working, and connected to PWM feeder and to, at least one power source, which output is connected to the module with HB LED diodes.

Advantageously, the sensors' module contains a PIR motion sensor, a noise sensor and a dusk sensor, or is equipped with dusk sensor or camera only.

The invention made possible a remote control of all functions of lamps and a comprehensive assessment of lighting system power consumption efficiency at any time, providing, among others, information about momentary power consumption or consumption per unit, relating to individual lamps, lamp subgroup, section, quarter or the whole lighting system, information about all essential lamp working parameters, about break-downs, their nature and location of damaged lamp—notifying immediately the maintenance service, about attempts to steal a lamp—alarming immediately the relevant services, taking care of security in the area—security agencies, municipal guard, police.

In addition to that, it became possible to build up quickly a lighting management system without necessity to expand the infrastructure—cabling, control substations, etc.—it is enough to replace lamps with the new-ones.

### BRIEF DESCRIPTION OF THE DRAWINGS

The object of invention is shown in drawings, where

FIG. 1 shows the external lighting installation, in the first advisable execution example, made according to the invention in general outline,

FIG. 2 the external lighting installation, in another advisable execution example, made according to the invention in general outline,

FIG. 3 the outline of communication between units, presented as constructional solution of lighting lamps controlling system, made according to the invention,

FIG. 4 the block diagram of the external lighting lamp in advisable execution example,

FIG. 5 the block diagram of the main controlling unit, in execution example as MASTER lamp,

FIG. 6 the block diagram of the main controlling unit, in execution example as STANDARD lamp,

FIG. 7 the block diagram of the main controlling unit, in another execution example as STANDARD lamp

FIG. 8 the block diagram of the main controlling unit, in another successive execution example as STANDARD,

FIG. 9 the block diagram of individual module of external lighting lamp feeder, in advisable execution example.

### DETAILED DESCRIPTION OF THE INVENTION

According to the invention, the method of controlling electrical devices, particularly external lighting lamps, connected to supply network consists in this, that management and diagnostic centre as well as lamps are equipped with individual controlling modules and radio or GSM communication modules. The modules of particular lamps are synchronized with each other and with the management and diagnostic centre. They exchange information through the radio network or GSM, off-supply network, in the predetermined communication cycles. The exchanged information can be preserved in particular lamps and transmitted to other lamps after terminating communication cycle with the management and diagnostic centre, if such information is assigned for other lamps working in the area. Lamps send individual information about their conditions and predetermined parameters and receive information concerning working conditions and parameters to be set by each particular lamp. They exchange information with the management and diagnostic centre or with main lamp, working in the area, which—in turn—collect information and transmit it to the management and diagnostic centre, and transmit information received from the management and diagnostic centre to particular lamps.

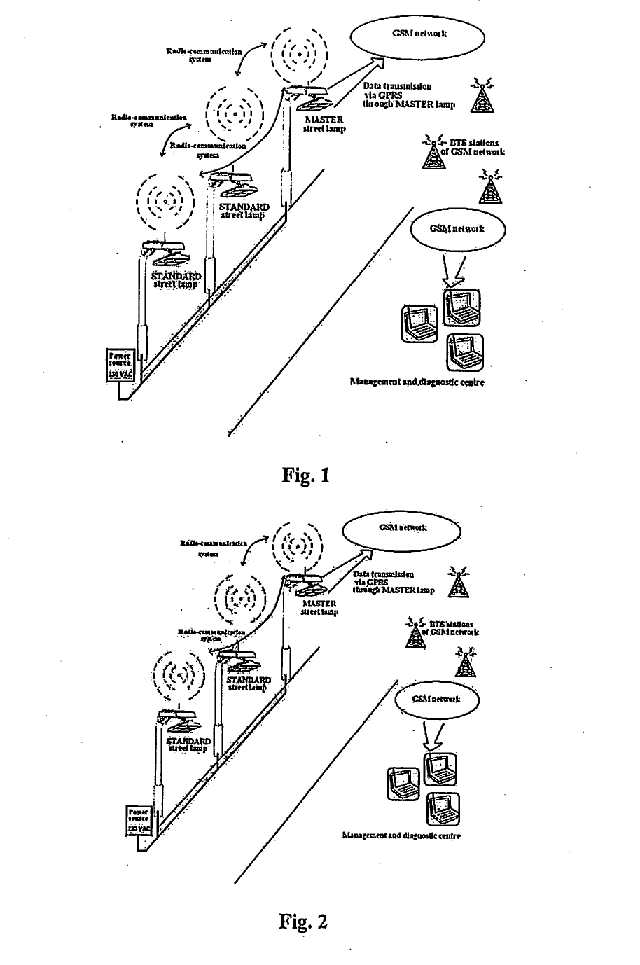

As shown in the FIG. 1, the system—according to the invention—is composed of external lighting STANDARD and MASTER lamps, for example with LED modules, connected to one common or several different supply networks, which are assigned only for supplying in power particular lamps working in the given area, but neither for transmitting information, nor for controlling the lamps—switching them on/off, adjusting light intensity. The lamps contain controlling modules, connected to radio or GSM operated data transmission modules.

According to the execution example shown in FIG. 1 each STANDARD lamp of the system communicates with every other STANDARD lamp of the system as well as with the MASTER lamp, and each one exchange information with management and diagnostic centre, while in the execution example shown in FIG. 2 STANDARD lamps of the system, working in given area, communicate with one main MASTER lamp, which exchanges information with management and diagnostic centre. It is obvious, that exclusively MASTER lamps may be used in the system. It will allow the system to operate more flexibly—each lamp may take over control of other lamps in a large area and exchange information with management and diagnostic centre.

As information exchange with lamps is effected via radio or GSM, it is possible to change data predetermined for each particular lamp i.e. individualization of working parameters during the inspection of illuminated area by a service staff. This allows, for example, to increase intensity of lighting, provided by some lamps, and decrease it for other lamps if they stand at different distances from the illuminated area, such as street.

Another advantage of the system is, that information is not exchanged through the supply line. Due to that, it is possible to group the lamps, which are controlled in given area, regardless their feeding lines, as well as to switch them off, in case of no need to illuminate the area—repair, rebuilding etc.

The method of lighting lamp controlling consists in the following: lamp working parameters are introduced into MCU MASTER input power values; then, signals controlling the lamp are transmitted from management and diagnostic centre via radio or GSM. The information is preserved and transmitted by MCU MASTER main controlling unit of the lamp, which automatically carries out the appropriate changes in lamp working program, as well as it executes commands inserted previously into MCU MASTER main controlling unit memory, and transmits to management and diagnostic centre information about lamp working conditions and parameters measured by sensors.

The measurements of lamp and environment temperature, as well as input power values, are effected by the lamp while working, and their results are taken into account when carrying out transmitted or memorized commands.

During the lamp operation, measurements are also effected by lamp external sensors, connected to MCU MASTER main controlling unit, and their results are taken into account when carrying out transmitted or memorized commands.

External sensors, connected to MCU MASTER main controlling unit are, for example: a dusk sensor, which can transmit information about current natural light intensity, and—if predetermined minimum is exceeded—about the necessity of lighting earlier switching on; a noise sensor and a motion sensor, which can transmit information about traffic increase in the illuminated area, and—consequently, about the necessity of increasing lamp's light intensity, or about decline of traffic—so, about possibility to reduce lamp's light intensity in given area to the minimum.

In the course of nature, a camera can replace both PIR motion sensor and noise sensor, and transmit in the real time to management and diagnostic centre information about changes of traffic intensity in the illuminated area.

Sensors may also provide protection of lamps against theft or damage.

Signals about lamp working status, containing lamp and environment temperature, input power value and lamp sensors' measurements data are preserved in MCU MASTER main controlling unit's memory. They are sent to management and diagnostic centre, where they are are taken into account when preparing information and transmitting it from management and diagnostic centre to the lamp. The management and diagnostic centre can transmit a command to change lamp's working mode.

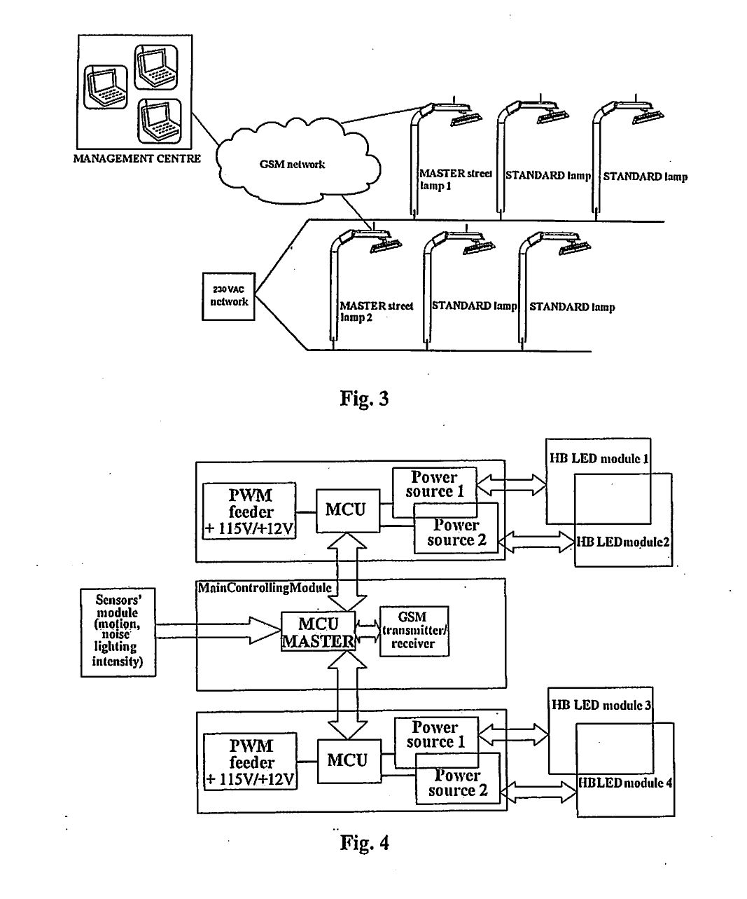

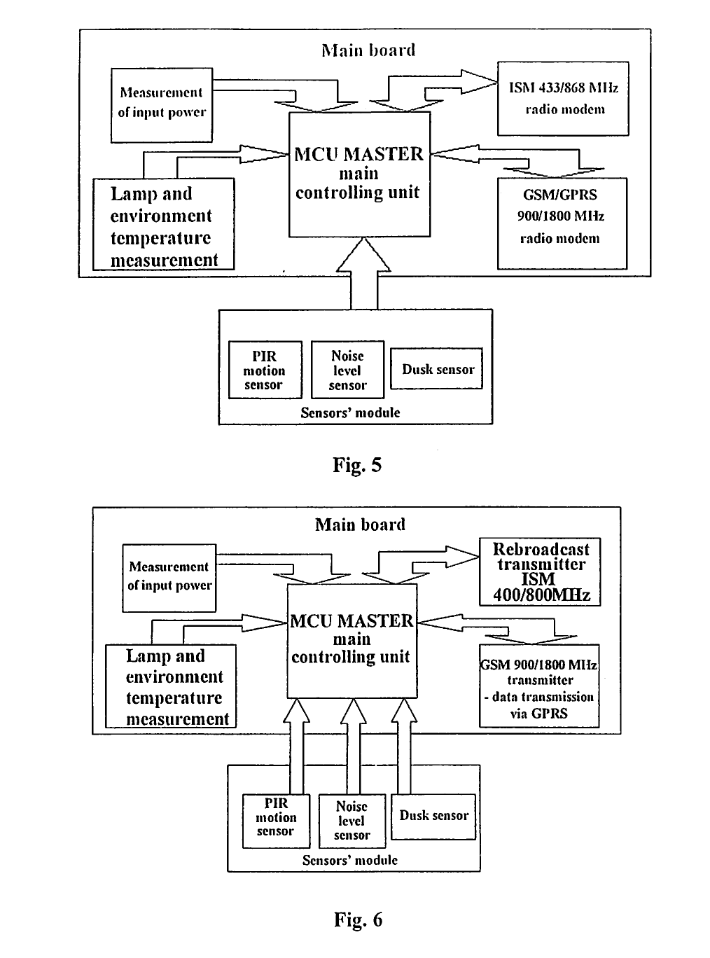

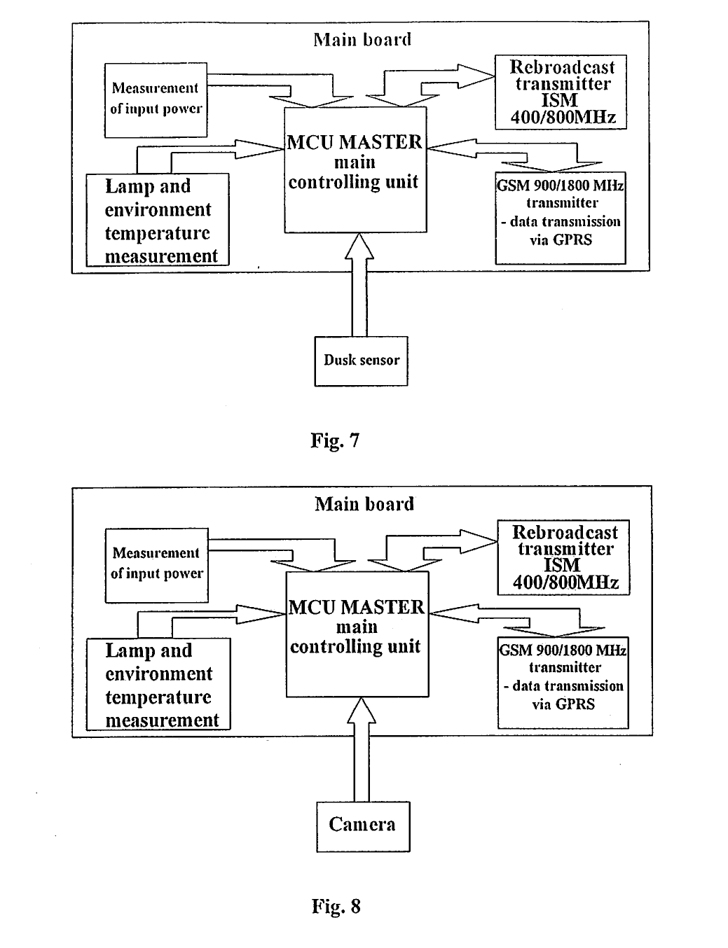

As shown in FIG. 4, the external lighting lamp is a lamp using modules with HB LED diodes as the light sources. The lighting lamp is fed from the supply line. The lamp contains a main controlling module, equipped with MCU MASTER main controlling unit, connected to input power measuring unit, lamp and environment temperature measuring unit as well as to GSM transmitter/receiver. The MCU MASTER main controlling unit is additionally connected to MCU central unit, controlling operations of feeding module, sensors' module or—as it is shown in FIG. 6—dusk sensor, or—as in execution version shown in FIG. 7—camera. As shown in FIG. 8 the sensors' module is composed of PIR motion sensor, noise sensor and dusk sensor. The selection of sensors depends on parameters, chosen as essential for controlling the lamp in given area. The number of feeding modules depends only on desired lighting parameters to be achieved, it means—on number of used light sources, for example—on number of modules with HB LED diodes.

The FIG. 5 shows the lamp, made according to invention, in MASTER version, i.e. the lamp, collecting information from all STANDARD lamps working in given area, and transmitting it to management and diagnostic centre, which—in turn—supplies the MASTER lamp with a comprehensive information and commands for MASTER lamp and all STANDARD lamps mating with MASTER lamp in given area. After that, the MASTER lamp transmits respective information to particular STANDARD lamps. The MASTER lamp is equipped with an ISM radio modem, for example 433.868 MHz and with a GSM/GPRS radio modem, for example 900/1800, while STANDARD lamps shown in FIGS. 6-8 are equipped with an ISM radio rebroadcast transmitter, for example 400/800 MHz and with a GSM transmitter, for example 900/1800 assigne for data transmission via GPRS.

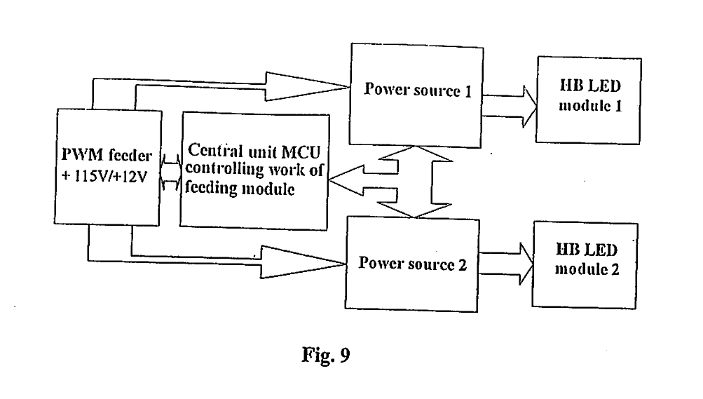

As shown in FIG. 9, the feeder module contains a central MCU unit, controlling operations of feeder module, a PWM feeder, for example +115V/+12V and power sources supplying directly modules with HB LED diodes.

The lamp construction and system solutions described above enable a remote diagnostic of lamp parameters—information about power consumption and working parameters, a remote monitoring of supply network parameters (voltages, currents, cos fi) and allows to notify immediately the appropriate service staff, if deviations from standards are stated. This allows to reduce costs of lamp maintenance and servicing and to act the service staff in a more efficient way—respond swiftly in case of break-downs and cut down the number of inspection travels. The constructional solutions enable also to adjust working parameters, regardless the environment temperature, to effect a constant monitoring of noise and generate automatically related reports, a continuous power consumption measurement for chosen sectors/quarters/districts or towns allowing to make a comparative analysis of effects of different time algorithms applied for street lighting adjustment at night and enabling to program individual parameters for each particular lamp location as well as to generate specialistic reports on system operations. It gives also possibility to program reduction of lighting within any period of time, depending on traffic, location, etc.—allowing to optimize lamps' lighting time. For example, when people's or vehicles' traffic intensity increase is registered, the intensity of lighting in the closest area increases too. It is possible to generate continuously reports on current traffic intensity in chosen sector or street, to transmit immediately information about break-down or impaired operation of lamp, its location and required repair range, to notify immediately any attempt to steal the lamp or its theft, to identify automatically lamps mating in group and lamps being added. There is no need to use external devices to control the system—all functions are located and effected in the lamp.

It is obvious, that constructional solutions presented above are taken by the way of example and do not impose restrictions on the essence of invention.

1. The method of controlling electrical devices, particularly external lighting lamps, connected to the supply network, characterized in that the management and diagnostic centre as well as lighting lamps are equipped with individual controlling modules and radio-communication or GSM modules, whilst the modules of individual lighting lamps are synchronized with each other and with the management and diagnostic centre as well they exchange information through the radio network or GSM regardless the power supply network in the predetermined communication cycles, and the information can be preserved in lamps' controlling modules in each individual lamp and transmitted to other lighting lamps after terminating communication cycle with the management and diagnostic centre, if such information is assigned for other lighting lamps working in the given operation area.

2. The method according to the claim 1, characterized in that lamps send individual information about their working conditions and predetermined parameters and receive information from management and diagnostic centre concerning working conditions and parameters to be set by each individual lamp.

3. The method according to the claim 1, characterized in that lamps exchange information with the main lamp in the given operation area and said main lamp collects such information and sends them to the management and diagnostic centre, and transmits information received from the management and diagnostic centre to each, individual lamp.

4. The electrical devices' control system, particularly the system controlling external lighting lamps, connected to the supply network, characterized in that the contains at least one management and diagnostic centre with communication modules, fed by any supply network, and external lighting lamps, connected to any supply network, and these lamps contain controlling modules and communication modules, whilst exchange of data between management and diagnostic centre and individual lamps as well as between lamps themselves takes place in real time, within set communication cycles and said information can be preserved in individual lamps, in MCU MASTER main controlling unit of the lamp and transmitted to other lamps after closing the communication cycle with management and diagnostic centre, and changes transmitted from management and diagnostic centre are carried out by MCU MASTER main controlling unit of each lamp.

5. The method of lighting lamp control, characterized in that lamp working parameters are introduced into said lamp MCU MASTER main controlling unit memory, then signals controlling the lamp are transmitted from management and diagnostic centre via radio or GSM, whilst the information are preserved and transmitted by MCU MASTER main controlling unit of the lamp, which automatically carries out the appropriate changes in lamp working program, as well as it executes commands inserted previously into MCU MASTER main controlling unit memory, and also transmits to management and diagnostic centre information about lamp working conditions and parameters measured by sensors.

6. The method according to the claim 5, characterized in that measurements of lamp and environment temperature, as well as input power values, are effected by the lamp, and their results are taken into account when carrying out transmitted or memorized commands.

7. The method according to the claim 5, characterized in that measurements are effected by lamp sensors, connected to MCU MASTER main controlling unit, and measurement results are taken into account when carrying out transmitted or memorized commands.

8. The method according to the claim 5, characterized in that signals of lamp working conditions, containing information about lamp and environment temperature, as well as input power values and measurements effected by lamp sensors are preserved in MCU MASTER main controlling unit memory and send to management and diagnostic centre, where measurement results are taken into account when working out and transmitting to the lamp information from management and diagnostic centre.

9. The lighting lamp, used particularly for external lighting, containing a standard joint, connecting it to power supply cables, as well as lighting elements, characterized in that contains a main controlling module, a sensors' module, at least one module of feeder and at least one module with HB LED diodes and the main controlling module contains MCU MASTER main controlling unit, connected to radio transmitter/receiver for data transfer, to lamp and environment temperature measurement module, to sensors' module, and at least to one MCU central controlling unit of lighting elements' feeder module.

10. The lighting lamp, according to the claim 9, characterized in that ISM radio modem, GSM/GPRS radio modem is its radio transmitter/receiver.

11. The lighting lamp, according to the claim 9, characterized in that ISM radio transmitter and GSM transmitter is its radio transmitter/receiver.

12. The lighting lamp, according to the claim 9, characterized in that the MCU MASTER main controlling unit is equipped with a memory, enabling to preserve information, containing transmitted commands, concerning lighting intensity control, lighting time, lighting switch on/off time, and the MCU MASTER main controlling unit automatically executes commands inserted previously and not changed, as well as preserves data received from sensors and transmits this information automatically or on request.

13. The lighting lamp, according to the claim 9, characterized in that the feeder's module contains a central MCU unit, controlling its working, and connected to PWM feeder and to, at least one power source, which output is connected to the module with HB LED diodes.

14. The lighting lamp, according to the claim 9, characterized in that the sensors' module contains a PIR motion sensor, a noise sensor and a dusk sensor.

15. The lighting lamp, according to the claim 9, characterized in that the sensors' module contains a dusk sensor.

16. The lighting lamp, according to the claim 9, characterized in that the sensors' module contains a camera.
